(19) United States
(12) Patent Application Publication
(10) Pub. No.: US 2024/0242886 A1
(43) Pub. Date: Jul. 18, 2024

(54) Composite Structure

(71) Applicant: Ticona LLC, Florence, KY (US)

(72) Inventors: Hongyu Chen, Shanghai (CN); Fangfang Tao, Shanghai (CN); Lili Ding, Shanghai (CN)

(21) Appl. No.: 18/406,298

(22) Filed: Jan. 8, 2024

Related U.S. Application Data
(60) Provisional application No. 63/479,009, filed on Jan. 9, 2023.

(51) Int. Cl. H01G 4/224; B60L 15/00; C08K 13/04; C08L 81/02; H01G 4/32; H01G 4/33

(52) U.S. Cl. CPC H01G 4/224; B60L 15/007; C08K 13/04; C08L 81/02; H01G 4/32; H01G 4/33; C08K 7/14; C08L 2203/20

(57) ABSTRACT

A composite structure comprising a first layer positioned adjacent to a second layer is provided. The first layer contains a polymer composition and the second layer contains a resinous material. The polymer composition includes a polyarylene sulfide and a bifunctional polymer that contains an epoxide functional group and a (meth)acrylate functional group. The resinous material includes a thermoset resin.

### RELATED APPLICATION

The present application is based upon and claims priority to U.S. Provisional Patent Application Ser. No. 63/479,009, having a filing date of Jan. 9, 2023, which is incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. For example, the powertrain may include an inverter that can produce alternating current (AC) from direct current (DC). To accomplish this conversion, the inverter may, for instance, employ a bridge circuit that includes a film capacitor in combination with one or more diodes and switching elements (e.g., transistors). The film capacitor generally includes an outer case formed from high performance polymer materials to help protect the interior capacitor element from the external environment. A filling resin (e.g., epoxy resin) may also be disposed in the space between the outer case and the capacitor element to help mechanically stabilize the capacitor element during use. Unfortunately, however, the polymer materials of the outer case often exhibit poor adhesion to the sealing resin, which adversely impacts performance, particularly at high temperatures. As such, a need currently exists for an improved structure having improved adhesion between a high performance polymer material and a sealing resin.

### SUMMARY OF THE INVENTION

In accordance with one embodiment of the present invention, a composite structure is disclosed that comprises a first layer positioned adjacent to a second layer. The first layer contains a polymer composition and the second layer contains a resinous material. The polymer composition includes a polyarylene sulfide and a bifunctional polymer that contains an epoxide functional group and a (meth)acrylate functional group. The resinous material includes a thermoset resin.

In accordance with another embodiment of the present invention, a film capacitor is disclosed that comprises a capacitor element that includes first metallized films electrically connected to a first termination and second metallized films electrically connected to a second termination. The capacitor also contains a a case within which the capacitor element is disposed. The case contains a polymer composition that includes a polyarylene sulfide and a bifunctional polymer that contains an epoxide functional group and a (meth)acrylate functional group. A space is formed between an inner surface of the case and an outer surface of the capacitor element. A resinous material is in contact with the capacitor element and the case and disposed in the space, wherein the resinous material includes a thermoset resin.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1A is a schematic cross-sectional view of one embodiment of a film capacitor that may contain the composite structure of the present invention;

FIG. 1B is a cross-sectional view taken along the line A-A FIG. 1A;

FIG. 2A is a schematic perspective view of one embodiment of a capacitor element defining the film capacitor;

FIG. 2B is a cross-sectional view taken along the line B-B in FIG. 2A;

FIG. 3 is a schematic perspective view of one embodiment of a wound body shown in FIGS. 2A and 2B;

FIG. 4 is a schematic perspective view of another embodiment of the wound body shown in FIGS. 2A and 2B;

FIG. 5A, FIG. 5B, and FIG. 5C are schematic diagrams of one embodiment of a method of producing a film capacitor;

FIG. 6 illustrates an electric vehicle including components that may incorporate the composite structure of the present invention;

FIG. 7 illustrates an inverter system as may be present in an electric car including components that may incorporate the composite structure of the present invention;

FIG. 8 illustrates two separate injected molded parts that can bonded together with an epoxy adhesive according to the Adhesion Test described herein;

FIG. 9 illustrates the process of placing the first injection molded part of FIG. 8 and an epoxy adhesive into a tensile strength testing apparatus;

FIG. 10 illustrates the process for placing the second injection molded part of FIG. 8 onto the epoxy adhesive and bonding it thereto; and

FIG. 11 illustrates the process for testing the adhesion strength of the bonded injection molded parts of FIG. 10.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a composite structure that contains a first layer and a second layer. The first layer contains a polymer composition that includes at least one polyarylene sulfide and the second layer contains a resinous material that contains at least one thermoset resin (e.g., epoxy resin). By selectively controlling the particular nature of the components of the polymer composition, as well as their relative concentration, the present inventors have discovered that a composite structure can be achieved that has an improved adhesion strength between the first and second layers. For example, the polymer composition may include at least one bifunctional polymer that contains both epoxide and (meth)acrylate functional groups. Without intending to be limited by theory, it is believed that such polymers can help improve adhesion to the thermoset resinous material by increasing surface energy while also helping to provide a balance of good mechanical properties, thermal properties, and flowability to the resulting composition. If desired, the polymer composition may also be generally free of release additives having a melting temperature below about 70° C. (e.g., polyglycerol fatty acid esters). Without intending to be limited by theory, it is believed that such additives can readily migrate to the external surface of the polymer composition, particularly at high temperatures, where it can reduce the surface energy and adversely impact the ability of the composition to adequately adhere to thermoset resinous materials within the composite structure. The resulting adhesion strength of the polymer composition may, for example, be about 2.5 MPa or more, in some embodiments about 3 MPa or more, and in some embodiments, from about 3.5 MPa to about 8 MPa as determined according to the adhesion test described herein.

In addition to exhibiting a high degree of adhesion to thermoset resinous materials, the polymer composition may have also exhibit other properties that can allow the resulting composite structure to be used in various applications. For example, the polymer composition may exhibit good insulative properties. The insulative properties of the polymer composition may be characterized by a high comparative tracking index (“CTI”), such as about 210 volts or more, in some embodiments about 220 volts or more, in some embodiments about 250 volts or more, in some embodiments about 300 volts or more, in some embodiments from about 350 volts to about 600 volts, in some embodiments from about 375 to about 500 volts, and in some embodiments, from about 400 volts to about 4750 volts, as determined in accordance with IEC 60112:2003. The insulative properties may be achieved at relatively small thickness values, such as about 4 millimeters or less, in some embodiments about from about 0.2 to about 3.2 millimeters, and in some embodiments, from about 0.4 to about 3.0 millimeters (e.g., 0.8, 1.2, 2.5, or 3 mm). The polymer composition can also exhibit good flame retardant characteristics as determined according to UL 94 testing as described below. For instance, the polymer composition may achieve at least a V-1 rating, and typically a V-0 rating, for specimens having a thickness of 0.8 millimeters.

While exhibiting flame retardancy and high CTI values, the composition may still exhibit good flow properties as reflected by a relatively low melt viscosity, such as about 30 kP or less, in some embodiments about 20 kP or less, in some embodiments about 10 kP or less, in some embodiments about 5 kP or less, and in some embodiments, from about 2 to about 50 kP, as determined in accordance with ISO 11443:2021 at a temperature of about 310° C. and at a shear rate of 400 s⁻¹. Despite having a low melt viscosity, the polymer composition may nevertheless maintain a high degree of impact strength as well as tensile strength, which can provide enhanced flexibility for the resulting structure. For example, the polymer composition may exhibit a notched Izod impact strength of about 5 KJ/m² or more, such as in some embodiments from about 6 to about 50 KJ/m², and in some embodiments, from about 7 to about 30 KJ/m², as determined at a temperature of 23° C. in accordance with ISO 180:2019, as well as a Charpy notched impact strength of about 5 KJ/m² or more, such as in some embodiments from about 6 to about 30 KJ/m², and in some embodiments, from about 7 to about 20 KJ/m², as determined at a temperature of 23° C. in accordance with ISO 179-1:2010. For example, the composition may exhibit a tensile stress at break of about 50 MPa or more, in some embodiments from about 80 MPa to about 250 MPa, and in some embodiments, from about 100 to about 200 MPa; a tensile break strain of about 1% or more, in some embodiments from about 1.2% to about 5%; and/or a tensile modulus of about 8,000 MPa or more, in some embodiments from about 9,000 MPa to about 20,000 MPa, in some embodiments from about 10,000 MPa to about 18,000 MPa. The tensile properties may be determined in accordance with ISO 527:2019 at a temperature of 23° C. The composition may also exhibit a flexural strength of about 50 MPa or more, in some embodiments from about 100 to about 350 MPa, and in some embodiments from about 150 to about 300 MPa, and/or a flexural modulus of from about 5,000 to about 20,000, in some embodiments from about 8,000 MPa to about 18,000 MPa, and in some embodiments, from about 10,000 MPa to about 16,000 MPa. The flexural properties may be determined in accordance with ISO 178:2019 at a temperature of 23° C.

Various embodiments of the present invention will now be described in greater detail below.

### I. Polymer Composition

### A. Polyarylene Sulfide

The polymer composition generally contains one or more polyarylene sulfides, typically in an amount of from about 10 wt. % to about 70 wt. %, in some embodiments from about 20 wt. % to about 65 wt. %, in some embodiments from about 25 wt. % to about 60 wt. %, and in some embodiments, from about 30 wt. % to about 55 wt. % of the entire polymer composition. The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

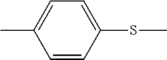

and segments having the structure of formula:

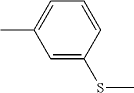

or segments having the structure of formula:

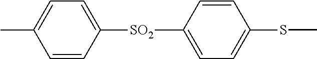

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xn, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any bifunctional polymers and the polyarylene sulfide, which can improve distribution of the bifunctional polymer throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

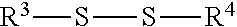

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at termination end(s) of the disulfide compound. For example, at least one of R³ and R⁴ may include a termination carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The melt flow rate of a polyarylene sulfide may be from about 100 to about 800 grams per 10 minutes (“g/10 min”), in some embodiments from about 200 to about 700 g/10 min, and in some embodiments, from about 300 to about 600 g/10 min, as determined in accordance with ISO 1133 at a load of 5 kg and temperature of 316° C.

The polyarylene sulfides, such as described above, typically have a DTUL value of from about 70° C. to about 220° C., in some embodiments from about 90° C. to about 200° C., and in some embodiments, from about 120° C. to about 180° C. as determined in accordance with ISO 75-2:2013 at a load of 1.8 MPa. The polyarylene sulfides likewise typically have a glass transition temperature of from about 50° C. to about 120° C., in some embodiments from about 60° C. to about 115° C., and in some embodiments, from about 70° C. to about 110° C., as well as a melting temperature of from about 220° C. to about 340° C., in some embodiments from about 240° C. to about 320° C., and in some embodiments, from about 260° C. to about 300° C.

### B. Bifunctional Polymer

As indicated above, a bifunctional polymer may also be employed within the polymer composition. Typically, the bifunctional polymer(s) constitute from about 1 to about 35 parts, in some embodiments from about 2 to about 30 parts, in some embodiments from about 5 to about 25 parts, and in some embodiments, from about 6 to about 20 parts by weight per 100 parts by weight of the polyarylene sulfide(s). For example, the bifunctional polymers may constitute from about 0.5 wt. % to about 20 wt. %, in some embodiments from about 1 wt. % to about 15 wt. %, and in some embodiments, from about 2 wt. % to about 10 wt. % of the polymer composition.

As noted above, the polymer is generally considered “bifunctional” in the sense that it that contains both epoxide and (meth)acrylate functional groups. As used herein, the term “(meth)acrylate” generally includes acrylic and methacrylic groups, as well as salts or esters thereof, such as acrylate and methacrylate groups. The epoxide and (meth)acrylate functional groups may be provide on the same monomeric unit of the polymer and/or on different monomeric units. In one embodiment, for example, the functional groups may be provided within the same monomeric unit. In such embodiments, for example, the bifunctional polymer may contain a monomeric unit that is derived from an epoxy-functional (meth)acrylate, such as, but not limited to, those containing 1,2-epoxy groups, such as glycidyl acrylate and glycidyl methacrylate. Other suitable epoxy-functional (meth)acrylates include glycidyl ethacrylate and glycidyl itoconate.

Of course, other suitable monomers may also be employed to help achieve the desired molecular weight. In one embodiment, for instance, the bifunctional polymer may also contain an olefinic monomeric unit that is derived from an α-olefin. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefins are ethylene and propylene. In one embodiment, for example, the bifunctional polymer may be a copolymer of an α-olefin (e.g., ethylene) and glycidyl (meth)acrylate. Another suitable monomeric unit that may optionally be employed may include one derived from a (meth)acrylate that is not epoxy-functional. Examples of such (meth)acrylates may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one embodiment, for example, the bifunctional polymer may be a copolymer of an α-olefin (e.g., ethylene), glycidyl (meth)acrylate, and a non-epoxy functional (meth)acrylate (e.g., butyl acrylate, methyl acrylate, etc.).

The relative portion of the monomeric unit(s) may be selected to achieve a balance between adhesive properties and melt flow rate. More particularly, high epoxy monomer contents can result in good adhesion with the polyarylene sulfide and thermoset resinous material, but too high of a content may reduce the melt flow rate to such an extent that the polymer adversely impacts the melt strength of the polymer blend. Thus, for example, epoxy-functional (meth)acrylate monomer(s) may constitute from about 1 wt. % to about 20 wt. %, in some embodiments from about 2 wt. % to about 15 wt. %, and in some embodiments, from about 3 wt. % to about 10 wt. % of the polymer. When employed, α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the polymer, and non-epoxy functional (meth)acrylate monomers may constitute from about 5 wt. % to about 35 wt. %, in some embodiments from about 8 wt. % to about 30 wt. %, and in some embodiments, from about 10 wt. % to about 25 wt. % of the copolymer.

The melt flow index of the bifunctional polymer may also be selectively controlled to help achieved the desired properties. For instance, the melt flow index of the bifunctional polymer may be from about 1 to about 30 grams per 10 minutes (“g/10 min”), in some embodiments from about 2 to about 20 g/10 min, and in some embodiments, from about 4 to about 15 g/10 min, as determined in accordance with ASTM D1238-20 at a load of 2.16 kg and temperature of 190° C. Particular examples of suitable bifunctional polymers that may be employed are commercially available from SK under the name LOTADER® AX8840 or AX8900. LOTADER® AX8840, for instance, is a random copolymer of ethylene and glycidyl methacrylate (8 wt. %), and has a melt flow melt index of 5 g/10 min at 190° C. LOTADER® AX8900 is a random copolymer of ethylene, methyl acrylate (24 wt. %), and glycidyl methacrylate (8 wt. %), and has a melt flow melt index of 6 g/10 min at 190° C. Another suitable copolymer is commercially available from Dow under the name ELVALOY® PTW, which is terpolymer a of ethylene, butyl acrylate, and glycidyl methacrylate (5 wt. %), and has a melt flow index of 12 g/10 min.

### C. Release Additive

As indicated above, the polymer composition may also be generally free of release additives having a melting temperature below about 70° C., in some embodiments below about 75° C., in some embodiments below about 80° C., and in some embodiments, below about 85° C. By “generally free”, it is contemplated that such additives are completely absent from the composition or, at the very least, present in only trace amounts. For example, such release additives are generally present in an amount of about 1,000 parts per million (“ppm’) or less, in some embodiments about 500 ppm or less, in some embodiments about 100 ppm or less, and in some embodiments, about 50 ppm or less (e.g., 0 ppm). Specific examples of release additives that have a melting temperature below 85° C. are polyglycerol fatty acid esters, such as pentaerythrityl-tetrastearate (melting point of about 60° C.), glycol distearate (melting point of about 65-73° C.), glycol stearate (melting point of about 55-60° C.), glycerol monostearate (melting point of about 57-65° C.), etc.

### D. Optional Components

In addition to the components noted above, the polymer composition may also contain a variety of other optional components to help improve its overall properties. As indicated, inorganic particulate fillers are also employed in the polymer composition. Various types of inorganic particulate fillers may be employed as is known in the art. Clay minerals, for instance, may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al, Mg, Fe)₂ (Si,Al)₄O₁₀[(OH)₂,(H₂O)]), montmorillonite (Na,Ca)_{0.33}(Al, Mg)₂Si₄O₁₀(OH)₂·nH₂O), vermiculite ((MgFe,Al)₃(Al,Si)₄O₁₀(OH)₂·4H₂O), palygorskite ((Mg,Al)₂Si₄O₁₀(OH)·4(H₂O)), pyrophyllite (Al₂Si₄O₁₀(OH)₂), etc., as well as combinations thereof. In lieu of, or in addition to, clay minerals, still other mineral fillers may also be employed. For example, other suitable fillers may include, for instance, carbonate fillers (e.g., calcium carbonate), silicate fillers (e.g., calcium silicate, aluminum silicate, mica, diatomaceous earth, wollastonite, etc.), sulfate fillers (e.g., barium sulfate, calcium sulfate, etc.). The inorganic particulate filler typically contains particles having an average size (e.g., diameter or length) in the range of about 1 to about 100 micrometers, in some embodiments from about 2 to about 80 micrometers, and in some embodiments, from about 5 to about 60 micrometers, such as determined using laser diffraction techniques in accordance with ISO 13320:2009 (e.g., with a Horiba LA-960 particle size distribution analyzer). In certain embodiments, the particles may have a generally spherical shape in that they have an aspect ratio (e.g., average length or diameter divided by average thickness) near 1, such as from about 0.6 to about 2.0, in some embodiments from about 0.7 to about 1.5, and in some embodiments, from about 0.8 to about 1.2. Due to their inherent flexibility in comparison to high aspect ratio materials, the use of generally spherical particles can help further improve the overall toughness and impact strength of the composition. In certain embodiments, generally spherical calcium carbonate particles may be particularly suitable for use in the present invention.

When employed, the amount of inorganic particulate fillers may be selectively controlled to achieve the desired properties. The fillers may, for example, be employed in an amount of from about 1 to about 50 parts, in some embodiments from about 2 to about 30 parts, and in some embodiments, from about 5 to about 20 parts per 100 parts by weight of the polyarylene sulfide(s). The fillers may, for instance, constitute from about 0.5 wt. % to about 20 wt. %, in some embodiments from about 1 wt. % to about 15 wt. %, and in some embodiments, from about 2 wt. % to about 10 wt. % of the polymer composition.

Although by no means required, reinforcing fibers may also be employed in certain embodiments of the present invention. Any of a variety of different types of reinforcing fibers may generally be employed, such as polymer fibers, metal fibers, carbonaceous fibers (e.g., graphite, carbide, etc.), inorganic fibers, etc., as well as combinations thereof. Inorganic fibers may be particularly suitable, such as those that are derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable, such as those formed from E-glass, A-glass, C-glass, D-glass, AR-glass, R-glass, S1-glass, S2-glass, etc., as well as mixtures thereof. If desired, the reinforcing fibers may be provided with a sizing agent or other coating as is known in the art. Regardless of the particular type selected, it is generally desired that the fibers have a relatively low elastic modulus to enhance the processability of the resulting polymer composition. The fibers may, for instance, have a Young's modulus of elasticity of less than about 76 GPa, in some embodiments less than about 75 GPa, and in some embodiments, from about 10 to about 74 GPa, as determined in accordance with ASTM C1557-14.

If desired, at least a portion of the reinforcing fibers may have a relatively flat cross-sectional dimension in that they have an aspect ratio of from about 1.5 to about 10, in some embodiments from about 2 to about 8, and in some embodiments, from about 3 to about 5. The aspect ratio is determined by dividing the cross-sectional width of the fibers (i.e., in the direction of the major axis) by the cross-sectional thickness of the fibers (i.e., in the direction of the minor axis). The shape of such fibers may be in the form of an ellipse, rectangle, rectangle with one or more rounded corners, etc. The cross-sectional width of the fibers may be from about 1 to about 50 micrometers, in some embodiments from about 5 to about 45 micrometers, and in some embodiments, from about 10 to about 35 micrometers. The fibers may also have a thickness of from about 0.5 to about 30 micrometers, in some embodiments from about 1 to about 20 micrometers, and in some embodiments, from about 3 to about 15 micrometers. It should be understood that the cross-sectional thickness and/or width need not be uniform over the entire cross-section. In such circumstances, the cross-sectional width is considered as the largest dimension along the major axis of the fiber and the cross-sectional thickness is considered as the largest dimension along the minor axis. For example, the cross-sectional thickness for an elliptical fiber is the minor diameter of the ellipse.

The reinforcing fibers may also have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. The fibers may be endless or chopped fibers, such as those having a length of from about 1 to about 15 millimeters, and in some embodiments, from about 2 to about 6 millimeters. The dimension of the fibers (e.g., length, width, and thickness) may be determined using known optical microscopy techniques.

When employed, the amount of reinforcing fibers may be selectively controlled to achieve the desired combination of CTI, flow, and mechanical properties. The reinforcing fibers may, for example, be employed in an amount of from about 30 to about 200 parts, in some embodiments from about 40 to about 150 parts, and in some embodiments, from about 50 to about 120 parts per 100 parts by weight of the polyarylene sulfide(s). The reinforcing fibers may, for instance, constitute from about 5 wt. % to about 60 wt. %, in some embodiments from about 10 wt. % to about 55 wt. %, and in some embodiments, from about 20 wt. % to about 50 wt. % of the polymer composition. The relative portion of the reinforcing fibers to the bifunctional polymer may also be selectively controlled. For example, the weight ratio of the reinforcing fibers to the bifunctional polymer may be from about 0.5 to about 15, in some embodiments from about 1 to about 12, and in some embodiments, from about 2 to about 10.

While optional, the polymer composition may also contains an epoxy resin. The epoxy resin can be selected to have a certain controlled epoxy equivalent weight, which can allow it to undergo a crosslinking reaction with the bifunctional polymer, thus improving compatibility of the components and increasing the mechanical properties of the resulting composition. The epoxy groups of the resin are also believed to further enhance the adhesion of the composition to metal components. When employed, the epoxy resin(s) typically constitute from about 0.1 to about 10 parts, in some embodiments from about 0.2 to about 5 parts, and in some embodiments, from about 0.3 to about 2 parts by weight per 100 parts by weight of the polyarylene sulfide(s). For example, epoxy resins may constitute from about 0.1 wt. % to about 10 wt. %, in some embodiments from about 0.2 wt. % to about 5 wt. %, and in some embodiments, from about 0.3 wt. % to about 1 wt. % of the polymer composition.

Epoxy resins having a certain epoxy equivalent weight are particularly effective for use in the polymer composition. Namely, the epoxy equivalent weight may generally be from about 250 to about 1,500, in some embodiments from about 400 to about 1,000, and in some embodiments, from about 500 to about 800 grams per gram equivalent as determined in accordance with ASTM D1652-11(2019). The epoxy resin also typically contains, on the average, at least about 1.3, in some embodiments from about 1.6 to about 8, and in some embodiments, from about 2 to about 5 epoxide groups per molecule. The epoxy content of the resin may thus typically range from about 20 wt. % to about 80 wt. %, in some embodiments from about 40 wt. % to about 75 wt. %, and in some embodiments, from about 50 wt. % to about 70 wt. % of the resin. The epoxy resin may have a relatively low dynamic viscosity, such as from about 1 centipoise to about 25 centipoise, in some embodiments 2 centipoise to about 20 centipoise, and in some embodiments, from about 5 centipoise to about 15 centipoise, as determined in accordance with ASTM D445-21 at a temperature of 25° C. At room temperature (25° C.), the epoxy resin is also typically a solid or semi-solid material having a melting point of from about 50° C. to about 120° C., in some embodiments from about 60° C. to about 110° C., and in some embodiments, from about 70° C. to about 100° C.

The epoxy resin can be saturated or unsaturated, linear or branched, aliphatic, cycloaliphatic, aromatic or heterocyclic, and may bear substituents which do not materially interfere with the reaction with the oxirane. Suitable epoxy resins include, for instance, glycidyl ethers (e.g., diglycidyl ether) that are prepared by reacting an epichlorohydrin with a hydroxyl compound containing at least 1.5 aromatic hydroxyl groups, optionally under alkaline reaction conditions. Dihydroxyl compounds are particularly suitable. For instance, the epoxy resin may be a diglycidyl ether of a dihydric phenol, diglycidyl ether of a hydrogenated dihydric phenol, etc. Diglycidyl ethers of dihydric phenols may be formed, for example, by reacting an epihalohydrin with a dihydric phenol. Examples of suitable dihydric phenols include, for instance, 2,2-bis(4-hydroxyphenyl) propane (“bisphenol A”); 2,2-bis 4-hydroxy-3-tert-butylphenyl) propane; 1,1-bis(4-hydroxyphenyl) ethane; 1,1-bis(4-hydroxyphenyl) isobutane; bis(2-hydroxy-I-naphthyl) methane; 1,5 dihydroxynaphthalene; 1,1-bis(4-hydroxy-3-alkylphenyl) ethane, etc. Suitable dihydric phenols can also be obtained from the reaction of phenol with aldehydes, such as formaldehyde) (“bisphenol F”). Commercially available examples of such epoxy resins may include EPON™ Resins available from Hexion, Inc. under the designations 862, 828, 826, 825, 1001, 1002, SU3, 154, 1031, 1050, 133, and 165.

In addition to the components noted above, the polymer composition may also contain a variety of other optional components to help improve its overall properties. In one embodiment, for instance, an organosilane compound may be employed in the polymer composition, such as in an amount of from about 0.1 to about 8 parts, in some embodiments from about 0.2 to about 5 parts, and in some embodiments, from about 0.3 to about 3 parts by weight per 100 parts by weight of the polyarylene sulfide(s). For example, organosilane compounds can constitute from about 0.01 wt. % to about 3 wt. %, in some embodiments from about 0.02 wt. % to about 2 wt. %, and in some embodiments, from about 0.05 to about 1 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

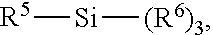

wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, Y-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

Still other components that can be included in the composition may include, for instance, antimicrobials, pigments (e.g., black pigments), antioxidants, stabilizers, surfactants, flow promoters, solid solvents, and other materials added to enhance properties and processability.

### II. Melt Processing

The manner in which the polyarylene sulfide(s), bifunctional polymer, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The melting temperature of the polymer composition may also range from 140° C. to about 380° C., in some embodiments from about 200° C. to about 360° C., in some embodiments from about 250° C. to about 320° C., and in some embodiments, from about 260° C. to about 300° C. The melting and crystallization temperatures may be determined as is well known in the art using differential scanning calorimetry in accordance with ISO 11357-3:2018.

### III. Composite Structure

As indicated above, the unique properties of the polymer composition can more readily allow it to be formed into a layer (e.g., first layer) that is capable of exhibiting strong adhesion properties to a layer (e.g., second layer) formed from a resinous material.

The resinous material typically contains a thermoset resin, such as an epoxy resin, vinyl ester resin, urethane resin, phenolic resin, etc. Epoxy resins may be particularly suitable for use in the composite structure, such as bisphenol A type epoxy resins, bisphenol F type epoxy resins, phenol novolac type epoxy resins, orthocresol novolac type epoxy resins, brominated epoxy resins and biphenyl type epoxy resins, cyclic aliphatic epoxy resins, glycidyl ester type epoxy resins, glycidylamine type epoxy resins, cresol novolac type epoxy resins, naphthalene type epoxy resins, phenol aralkyl type epoxy resins, cyclopentadiene type epoxy resins, heterocyclic epoxy resins, etc. Epoxy phenol novolac (“EPN”) resins, which are glycidyl ethers of phenolic novolac resins, may be particularly suitable. Specific examples of novolac-type epoxy resins may include a phenol-novolac epoxy resin, cresol-novolac epoxy resin, naphthol-novolac epoxy resin, naphthol-phenol co-condensation novolac epoxy resin, naphthol-cresol co-condensation novolac epoxy resin, brominated phenol-novolac epoxy resin, etc. If desired, the epoxy resin may be crosslinked with a co-reactant (hardener). Examples of such co-reactants may include, for instance, polyamides, amidoamines (e.g., aromatic amidoamines such as aminobenzamides, aminobenzanilides, and am inobenzenesulfonam ides), aromatic diamines (e.g., diaminodiphenylmethane, diaminodiphenylsulfone, etc.), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines (e.g., tetramethylguanidine), carboxylic acid anhydrides (e.g., methylhexahydrophthalic anhydride), carboxylic acid hydrazides (e.g., adipic acid hydrazide), phenolic-novolac resins (e.g., phenol novolac, cresol novolac, etc.), carboxylic acid amides, etc., as well as combinations thereof.

In addition to a thermoset resin and optional co-reactants, the resinous material also typically contains one or more inorganic oxide fillers, such as silica, alumina, zirconia, magnesium oxides, iron oxides (e.g., iron hydroxide oxide yellow), titanium oxides (e.g., titanium dioxide), zinc oxides (e.g., boron zinc hydroxide oxide), copper oxides, zeolites, silicates, clays (e.g., smectite clay), etc., as well as composites (e.g., alumina-coated silica particles) and mixtures thereof. Silica is particularly suitable for use in the resinous material. To help improve overall moisture resistance, the content of the inorganic oxide fillers may be maintained at a high level, such as about 50 wt. % or more, in some embodiments about 60 wt. % or more, and in some embodiments, from about 70 wt. % to about 90 wt. % of the resinous material. The thermoset resin (optionally reacted with co-reactants) likewise typically constitutes from about 0.5 wt. % to about 40 wt. %, in some embodiments from about 1 wt. % to about 35 wt. %, and in some embodiments, from about 5 wt. % to about 30 wt. % of the composition. Apart from the components noted above, it should be understood that still other additives may also be employed in the resinous material, such as photoinitiators, viscosity modifiers, suspension aiding agents, pigments, stress reducing agents, coupling agents (e.g., silane coupling agents), stabilizers, etc. When employed, such additives typically constitute from about 0.1 to about 20 wt. % of the resinous material.

The manner in which the layers of the composite structure are formed depends in part on the particular product application. In other words, depending on the particular product, the composite structure can be formed in situ as the product is being formed, or it may be simply formed as a standalone composite that can be later incorporated into a product. When employed in a film capacitor, for instance, the first layer of the composite structure may be initially pre-formed in the shape of a case. After a capacitor element is disposed within the case, it may then be filled with the resinous material for sealing the capacitor element. In such a product application, the composite structure is thus formed in multiple stages and includes the pre-formed case (first layer) and the subsequently applied resinous material (second layer). Of course, in other product applications, both the first and second layers may be pre-formed prior to being incorporated into the final product.

Regardless of the product application, the polymer composition may be formed into the first layer of the composite structure using a variety of techniques, such as by molding, film formation, extrusion, etc. In one embodiment, for example, the polymer composition may be molded into the desired shaper for the first layer. Suitable molding techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity.

The second layer formed from the resinous material may be incorporated into the composite structure before, during, or after the first layer is formed. When the first layer is molded, for example, the resinous material may be coated, poured, dipped, injected, or otherwise applied to the first layer and crosslinked to form the second layer. The thermoset resinous material may be initially provided in the form of a single or multiple compositions. For instance, a first composition may contain the thermoset resin and the second composition may contain the co-reactant. Regardless, once it is applied, the thermoset resinous material may be heated or allowed to stand at ambient temperatures so that the thermoset resin is allowed to crosslink with the co-reactant, which thereby causes the material to cure and harden into the desired shape. For instance, the composition may be heated to a temperature of from about 15° C. to about 150° C., in some embodiments from about 20° C. to about 120° C., and in some embodiments, from about 25° C. to about 100° C. Alternatively, the second layer may be pre-formed and the polymer composition may simply be molded onto or otherwise formed on the second layer to form the first layer of the composite structure.

While the composite structure has been described herein as containing a first layer and a second layer, it should be understood that the structure may contain any number of layers as desired. For example, the polymer composition may be used to form two or more layers, and likewise, the thermoset resinous material may be used to form two or more layers. Other materials may also be used to form layers on or adjacent to the first and/or second layers.

### IV. Film Capacitor

As indicated above, the unique properties of the polymer composition can more readily allow it to be more readily employed in a film capacitor. In certain embodiments, for example, the film may contain a capacitor element that is positioned within a case. The capacitor element may, for example, be a laminate (e.g., wound laminate) that includes one or more first metallized films that are electrically connected to a first external termination and one or more second metallized films that are electrically connected to a second external termination. The film may be formed from a polymer composition that includes a thermoplastic resin, such as a polyolefin (e.g., polypropylene), polyethersulfone, polyetherimide, polyarylate, urethane, etc. The thickness of the film is typically about 5 micrometers or less, in some embodiments about 3.5 micrometers or less, and in some embodiments, from about 0.5 to about 3 micrometers. The films may be metallized by forming a metal layer on or both surfaces thereof. The metal layer(s) may contain a metal, such as aluminum, titanium, zinc, magnesium, tin, nickel, etc. Any technique may be used to form the metal layers as is known in the art. For example, the metal layers may be sprayed, vapor-deposited, etc. onto the films. The thickness of each metal layer is typically about 5 micrometers or less, in some embodiments about 100 nanometers or less, and in some embodiments, from about 5 to about 40 nanometers.

The volume of the capacitor element is typically from about 30% to about 85% relative to the inner volume of the case so that a space is formed between an inner surface of the case and an outer surface of the capacitor element. The space may range, for example, from about 1 to about 5 millimeters, and in some embodiments, from about 1 to about 2 millimeters. The capacitor element may have an oblong cross section having a major axis of from about 15 to about 65 millimeters and a minor axis of from about 2 to about 50 millimeters, and the length of the capacitor element in a longitudinal direction (a direction from a front cross section to a rear cross section, including the external electrodes) may be from about 10 to about 50 millimeters. The case may likewise have an outer shape in which the long side of the bottom is from about 16 to about 73 millimeters, the short side of the bottom is from about 3 to about 78 millimeters, the height is from about 10.5 to about 50.5 millimeters, and the thickness is from about 0.5 to about 3 millimeters.

Regardless of the particular size and shape, the resinous material may be disposed within the case so that it is contact with the capacitor element and case and occupies at least a portion, if not all, of the space defined between the case and the capacitor element. The case may be formed from the polymer composition such that the resulting contact between the case and the resinous material forms a composite structure. If desired, the resinous material may include a first resin layer surrounding the capacitor element and a second resin layer disposed closer to the opening of the case than the first resin layer. The first resin layer and the second resin layer may be made of the same or different material.

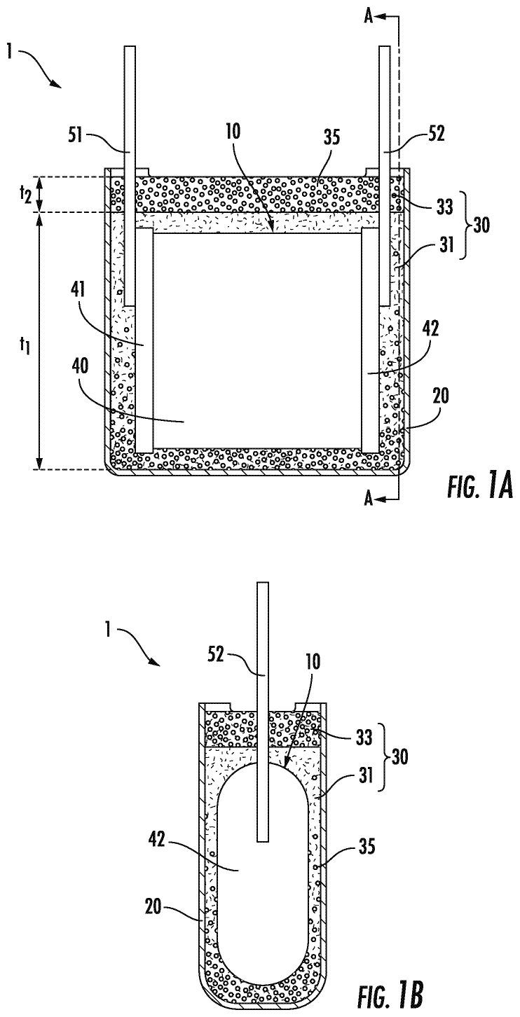

Referring to FIGS. 1A and 1B, for example, one embodiment of a film capacitor 1 is shown that includes a capacitor element 10. In the illustrated embodiment, the capacitor element 10 includes a wound body 40 of metallized films and a first external electrode 41 and a second external electrode 42 at the respective ends of the wound body 40. A first termination 51 is connected to the first external electrode 41, and a second termination 52 is connected to the second external electrode 42. The capacitor 1 also contains a case 20 that houses the capacitor element 10 and has a bottomed tubular shape having an opening at one end. The case 20 may be formed from the polymer composition described herein. In one embodiment, for example, the case may be formed by injection molding the polymer composition into the desired shape. In the film capacitor 1 shown, a rectangular parallelepiped space is formed in the case 20, and the capacitor element 10 is disposed apart from inner surfaces of the case 20 and centered in the case 20. To help hold and seal the capacitor element 10 within the case 20, the space between outer surfaces of the capacitor element 10 and the inner surfaces of the case 20 may be filled with a resinous material 30 as described above. Although by no means required, the resinous material 30 in the depicted embodiment includes a first resin layer 31 surrounding the capacitor element 10 from the bottom of the case 20 and a second resin layer 33 disposed closer to an opening of the case 20 than the first resin layer 31. The first and/or second resin layers may be formed from the resinous material as described above. In this manner, a composite structure is formed that includes the case 20, the first resin layer 31, and the second resin layer 33. If desired, a thickness t₂ of the second resin layer 33 may be smaller than a thickness t₁ of the first resin layer 31. For example, the thickness of the second resin layer may be about 50% or less, in some embodiments about 30% or less, and in some embodiments, about 15% or less of the thickness of a total thickness of both the first and second resin layers.

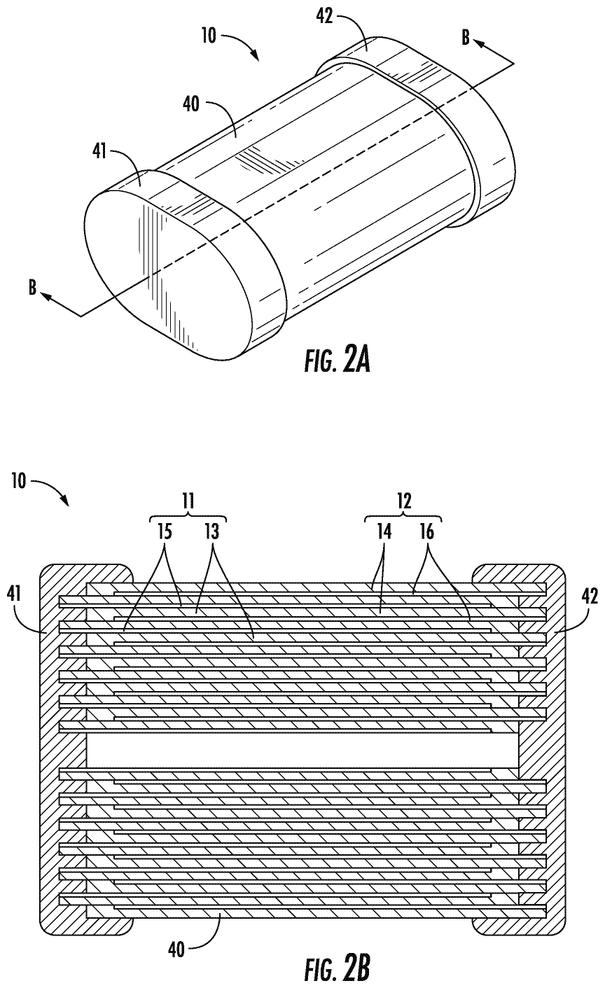

The capacitor element may have a pillar shape and an oblong cross section, and may include external electrodes formed by, for example, metal spraying at both ends of the pillar shape in the central axis direction. FIGS. 2A and B show one particular embodiment of the capacitor element that may be employed. As shown, the capacitor element 10 includes a wound body 40 of metallized films, each metallized film including a first metallized film 11 and a second metallized film 12 wound in a laminated state, and the first external electrode 41 and the second external electrode 42 connected to both end faces of the wound body 40. As shown in FIG. 2B, the first metallized film 11 may include a first resin film 13 and a first metal layer (counter electrode) 15 on a surface of the first resin film 13. The second metallized film 12 may include a second resin film 14 and a second metal layer (counter electrode) 16 on a surface of the second resin film 14. The first metal layer 15 and the second metal layer 16 oppose each other with the first resin film 13 or the second resin film 14 therebetween. Further, the first metal layer 15 is electrically connected to the first external electrode 41, and the second metal layer 16 is electrically connected to the second external electrode 42. The first metal layer 15 may be formed on one side of the first resin film 13 so that it extends to a first end but not to a second end. The second metal layer 16 may be formed on one side of the second resin film 14 so that it extends to the second end but not to the first end. The first external electrode 41 and the second external electrode 42 may be formed by, for example, spraying a metal (e.g., zinc) onto both end surfaces of the wound body 40 of the metallized films. The first external electrode 41 is in contact with the exposed end of the first metal layer 15, and is thus electrically connected to the first metal layer 15. The second external electrode 42 is in contact with the exposed end of the second metal layer 16, and is thus electrically connected to the second metal layer 16.

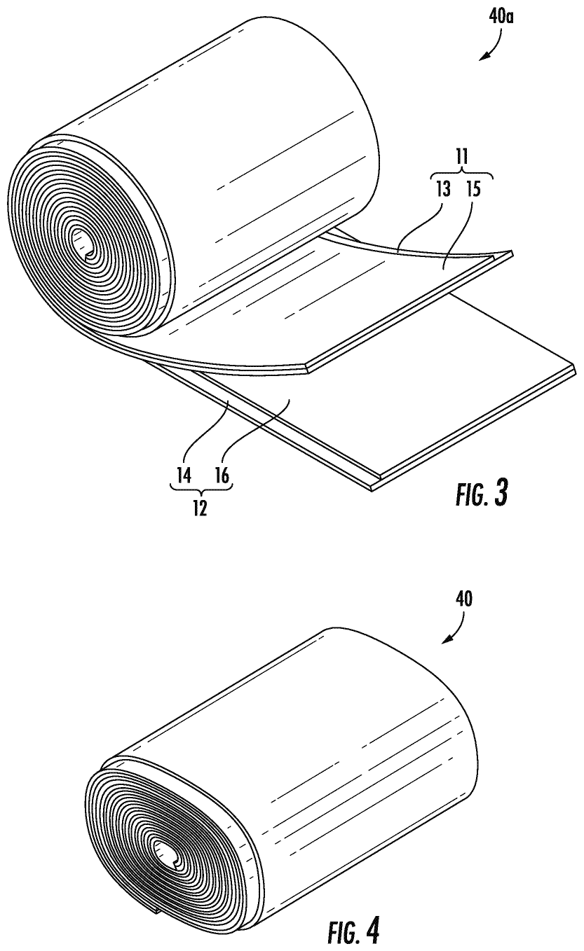

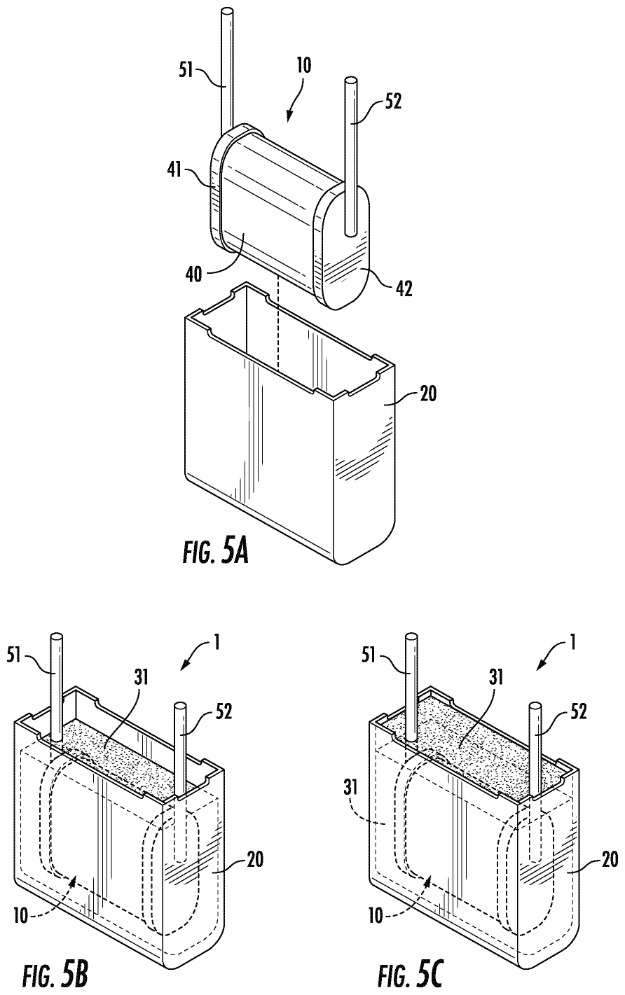

FIG. 3 is a schematic perspective view of one embodiment of a wound body shown in FIGS. 2A and 2B. As shown, the first resin film 13 and the second resin film 14 are laminated in a displaced relationship from each other in a width direction (in FIG. 2B, in a left-to-right direction) so that one end of the first metal layer 15 is exposed from the laminate and that one end of the second metal layer 16 is also exposed from the laminate. The first resin film 13 and the second resin film 14 may be wound in a laminated state into the wound body 40a. The first metal layer 15 and the second metal layer 16 are laminated while they maintain a state in which one end of the first metal layer 15 and one end of the second metal layer 16 are exposed. The first resin film 13 and the second resin film 14 may also be wound so that the second resin film 14 is outside the first resin film 13 and that the first metal layer 15 and the second metal layer 16 face inside. FIG. 4 is a schematic perspective view of another embodiment of the wound body 40 shown in FIGS. 2A and 2B. The wound body 40 of this embodiment may be formed by pressing the wound body 40a (FIG. 4) into a flat cross-sectional shape.

FIGS. 5A-5C are schematic diagrams of one example of the method of producing the film capacitor 1. As shown in FIG. 5A, the first external electrode 41 and the second external electrode 42 are formed on the respective ends of the wound body 40, the first lead terminal 51 and the second lead terminal 52 are welded to provide the capacitor element 10, and the capacitor element 10 is housed in the case 20. Then, as shown in FIG. 5B, the case 20 is filled with a thermoset resinous material, which is cured to form the first resin layer 31. Finally, as shown in FIG. 5C, an additional resinous material may be poured over the first resin layer 31 and cured to form the second resin layer 33.

### V. Electrical Vehicle

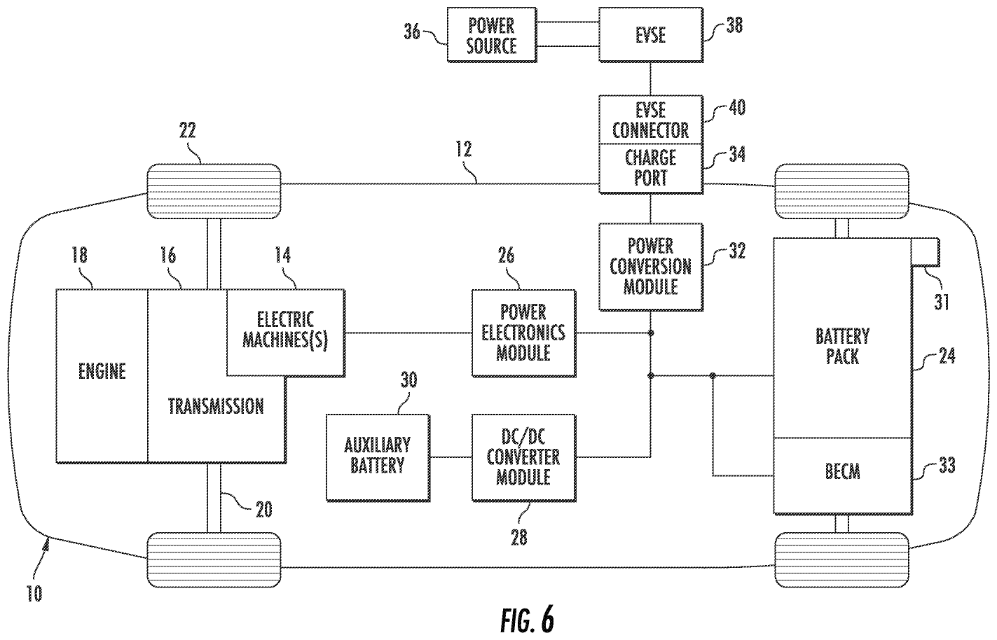

While the composite structure and film capacitor referenced above may be employed in a wide variety of applications, the present inventors have discovered that such components are particularly suitable for use in a powertrain of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 6, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, inverter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells. In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 36 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

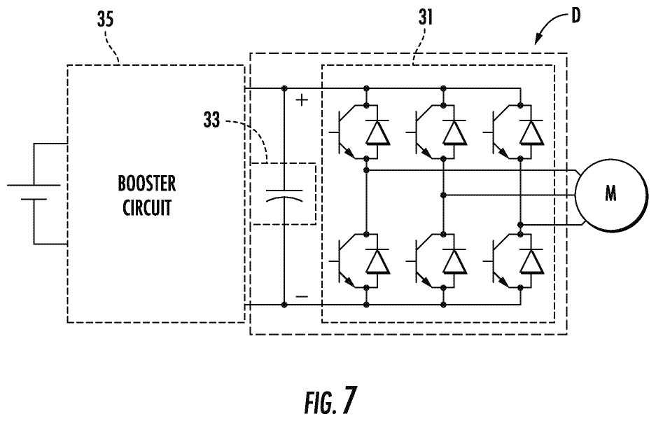

While not specifically illustrated, various electronic components of the powertrain 110 may employ the composite structure of the present invention. For example, when the composite structure is included within a film capacitor, the resulting capacitor may be employed in the power conversion module 132, power electronics module 126, battery energy control module (BECM) 133, etc. For example, the film capacitor may be particularly useful in a converter and/or inverter of a power conversion module 132. Referring to FIG. 7, for example, one embodiment of an inverter D is shown that can produce alternating current (AC) from direct current (DC). As illustrated, the inverter D may include a bridge circuit 31 that contains a capacitor 33 disposed across input terminals of the bridge circuit 31 for voltage stabilization. If desired, the film capacitor described above may be used as the capacitor 33. The bridge circuit 31 may also contain other electrical component as is known the art, such as diodes, switching elements (e.g., Insulated Gate Bipolar Transistor (IGBT)), etc. The inverter D is also connected to a booster circuit 35 for boosting the voltage of a direct current power supply and a motor generator (a motor M) serving as a driving source. Of course, the use of the composite structure is in no way limited to only electrical systems. For example, a thermal management system can also beneficially incorporate the composite structure. A thermal management system of an electric vehicle can generally include multiple different subsystems such as, without limitation, refrigeration subsystem, battery cooling subsystem, and heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

The present invention may be better understood with reference to the following examples.

### Test Methods

Melt Viscosity. The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Tensile Modulus, Tensile Stress at Break, and Tensile Strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Izod notched impact strength may be determined according to ISO 180:2019. Specimens were cut from the center of a multi-purpose bar using a single tooth milling machine. Testing temperature was 23ºC.

Notched Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C. or −30° C.

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

Flame Retardancy: The flame retarding efficacy may be determined according to the UL 94 Vertical Burn Test procedure of the “Test for Flammability of Plastic Materials for Parts in Devices and Appliances”, 5th Edition, Oct. 29, 1996. The ratings according to the UL 94 test are listed in the following table:

| Rating | Afterflame Time (s) | Burning Drips | Burn to Clamp |
|---|---|---|---|
| V-0 | <10 | No | No |
| V-1 | <30 | No | No |
| V-2 | <30 | Yes | No |
| Fail | <30 | | Yes |
| Fail | >30 | | No |

The “afterflame time” is an average value determined by dividing the total afterflame time (an aggregate value of all samples tested) by the number of samples. The total afterflame time is the sum of the time (in seconds) that all the samples remained ignited after two separate applications of a flame as described in the UL-94 VTM test. Shorter time periods indicate better flame resistance, i.e., the flame went out faster. For a V-O rating, the total afterflame time for five (5) samples, each having two applications of flame, must not exceed 50 seconds.

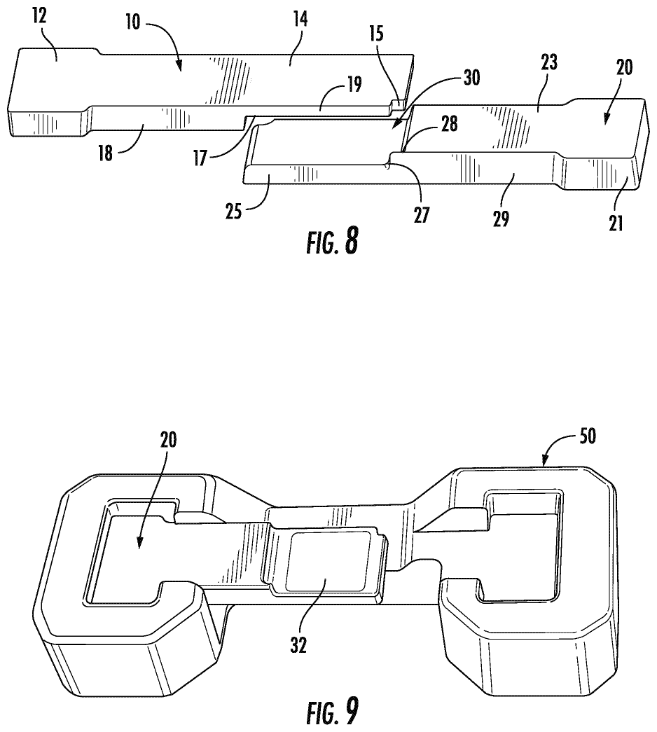

Adhesion Test: To test the adhesion strength of a polymer composition, two sample bars are initially injected molded from the same polymer composition, such as described herein. Referring to FIG. 8, for instance, a first sample bar 10 and a second sample bar 20 may be injected molded so that they define a bonding region 30 therebetween. The first sample bar 10 has a tab portion 12 and an elongated portion 14. The elongated portion 14 has a length of 42 mm and a width of 16 mm and the tab portion 12 has a length of 10 mm and a width of 20 mm. The elongated portion 14 also has a first section 18 having a thickness of 4 mm and a second section 19 having a second thickness of 2 mm. The differential thickness allows sufficient space for an epoxy adhesive to be disposed adjacent to a bottom surface 17 of the second section 19 of the elongated portion 14. Similar to the first sample bar 10, the second sample bar 20 also has a tab portion 21 and an elongated portion 23. The elongated portion 23 has a length of 42 mm and a width of 16 mm and the tab portion 21 has a length of 10 mm and a width of 20 mm. The elongated portion 23 also has a first section 29 having a thickness of 4 mm and a second section 25 having a second thickness of 2 mm. The differential thickness allows sufficient space for an epoxy adhesive to be disposed adjacent to an upper surface 27 of the second section 25 of the elongated portion 23.

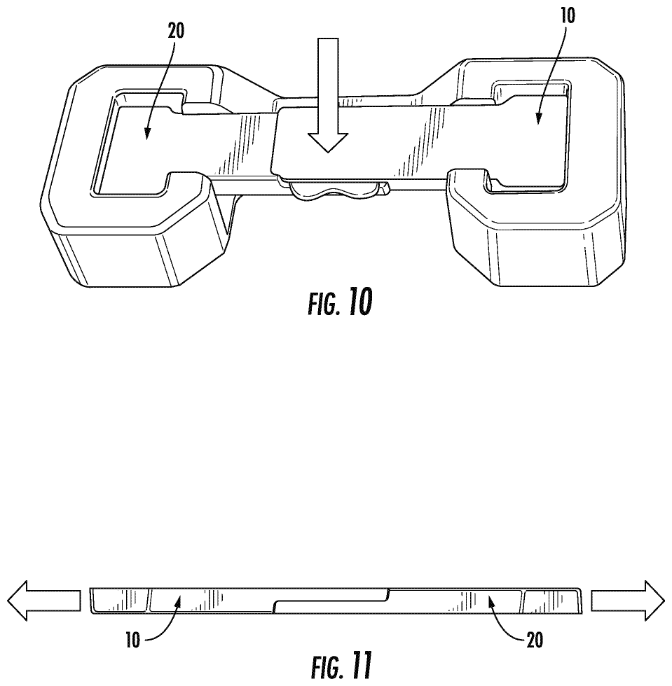

Once formed, the first and second sample bars are cleaned with alcohol using a Chem wipe to remove any residue. Thereafter, as shown in FIG. 9, the second sample bar 20 is disposed on one side of a conventional tensile testing apparatus. Using a small spatula, a small amount of an epoxy adhesive 32 is placed on the upper surface 27 of the second section 25 of the sample bar 20. The epoxy adhesive 32 is obtained from Sanyu Rec. Co., Ltd. under the trade designation “EE-102 A/B.”. Referring to FIG. 10, the first sample bar 10 is then disposed over the second sample bar 20 and the epoxy adhesive 32. Through the use of a clamp (30-mm Deli binder clamp), pressure is applied to the sample bars 10 and 20 as shown in FIG. 10 so that excess adhesive is squeezed out from the bonding region 30. The excess adhesive can be removed with a wipe and discarded. The sample bars 10 and 20 are then full aligned using locating features 15 and 28 on each of the sample bars 10 and 20, respectively. Once aligned, the epoxy adhesive is cured at a temperature of 85° C. in air for 2 hours and then at 115° C. for 4 hours. Tensile testing is then conducted at a temperature of about 23° C. and testing speed of 5 mm/min in accordance with ISO 527:2019. The “adhesion strength” is recorded as the tensile strength (i.e., tensile stress at break) resulting from the tensile testing.

### Comparative Examples 1-2 and Examples 1-2

Various samples were melt mixed using a 32 mm Coperion co-rotating, fully-intermeshing, twin-screw extruder and include various concentrations of a polyarylene sulfide, impact modifier, glass fibers, epoxy resin, black pigment, calcium carbonate, polyethersulfone, aminosilane coupling agent, and lubricant (pentaerythritol stearate). The impact modifier is a random terpolymer of ethylene, methyl acrylate (24 wt. %), and glycidyl methacrylate (8 wt. %), and has a melt flow melt index of 6 g/10 min at 190° C. The epoxy resin is EPON™ 1002F (Hexion), which is a solid epoxy resin derived from a liquid epoxy resin and bisphenol-A and that has two (2) moles epoxide groups per mole of resin, an epoxy equivalent weight of 600 to 700 grams per equivalent weight as determined according to ASTM D1652-11(2019), and an epoxy content of from about 55-65 wt. %). The formulations of each example are set forth in more detail in the table below.

| | Comp. Ex. 1 | | Comp. Ex. 2 | | Ex. 1 | | Ex. 2 | |
|---|---|---|---|---|---|---|---|---|
| | Wt. % | Parts | Wt. % | Parts | Wt. % | Parts | Wt. % | Parts |
| PPS | 56.8 | 100 | 44.5 | 100 | 44.8 | 100 | 42.6 | 100 |
| Polyethersulfone | — | — | 6 | 13.5 | — | — | — | — |
| Glass Fibers | 40 | 70 | 40 | 90 | 40 | 90 | 40 | 94 |
| Calcium Carbonate | — | — | 7 | 15.7 | 7 | 15.7 | 7 | 16.4 |
| Pentraerythitrol Stearate | 0.3 | 0.5 | — | — | — | — | 0.2 | 0.5 |
| Epoxy Resin | — | — | 0.5 | 1.1 | — | — | — | — |
| Impact Modifier | — | — | — | — | 6 | 13.4 | 8 | 18.8 |
| Aminosilane Coupling | 0.4 | 0.7 | — | — | 0.2 | 0.4 | 0.2 | 0.5 |
| Agent | | | | | | | | |
| Black Pigment | 2.5 | 3.5 | 2.0 | 4.5 | 2.0 | 4.5 | 2.0 | 4.7 |

Once formed, the resulting compositions were tested for shear strength as described above. The shear strength values were 2.32 MPa (Comp. Ex. 1), 2.25 MPa (Comp. Ex. 2), 4.27 MPa (Ex. 1), and 3.87 MPa (Ex. 2).

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A composite structure comprising a first layer positioned adjacent to a second layer, wherein the first layer contains a polymer composition and the second layer contains a resinous material, wherein the polymer composition includes a polyarylene sulfide and a bifunctional polymer that contains an epoxide functional group and a (meth)acrylate functional group, and further wherein the resinous material includes a thermoset resin.

2. The composite structure of claim 1, wherein the polymer composition exhibits a melt viscosity of about 30 kP or less as determined in accordance with ISO 11443:2021 at a temperature of about 310° C. and at a shear rate of 400 s⁻¹.

3. The composite structure of claim 1, wherein bifunctional polymers are present in the polymer composition in an amount of from about 1 to about 35 parts by weight per 100 parts by weight of polyarylene sulfides.

4. The composite structure of claim 1, wherein the bifunctional polymer contains a monomeric unit derived from an epoxy-functional (meth)acrylate.

5. The composite structure of claim 4, wherein the epoxy-functional (meth)acrylate includes glycidyl acrylate, glycidyl methacrylate, or a combination thereof.

6. The composite structure of claim 4, wherein the bifunctional polymer further includes a monomeric component derived from an α-olefin.

7. The composite structure of claim 6, wherein the monomeric unit derived from the epoxy-functional (meth)acrylate constitutes from about 1 wt. % to about 20 wt. % of the bifunctional polymer.

8. The composite structure of claim 6, wherein the bifunctional polymer is a copolymer of ethylene and glycidyl (meth)acrylate.

9. The composite structure of claim 6, wherein the copolymer further contains a monomeric unit derived from a (meth)acrylate that is not epoxy-functional.

10. The composite structure of claim 1, wherein the bifunctional polymer has a melt flow index of from about 1 to about 30 grams per 10 minutes, as determined in accordance with ASTM D1238-13 at a load of 2.16 kg and temperature of 190° C.

11. The composite structure of claim 1, wherein the polymer composition is generally free of release additives having a melting temperature below about 70° C.

12. The composite structure of claim 1, wherein the polymer composition is free of pentaerythrityl-tetrastearate.

13. The composite structure of claim 1, wherein the polymer composition further includes reinforcing fibers.

14. The composite structure of claim 13, wherein the reinforcing fibers include glass fibers.

15. The composite structure of claim 1, wherein the polymer composition further includes an inorganic particulate filler.

16. The composite structure of claim 1, wherein polyarylene sulfides constitute from about 10 wt. % to about 70 wt. % of the polymer composition.

17. The composite structure of claim 1, wherein the thermoset resin includes an epoxy resin.

18. The composite structure of claim 1, wherein the resinous material further includes an inorganic oxide filler.

19. The composite structure of claim 1, wherein the polymer composition exhibits an adhesion strength of about 2.5 MPa or more.

20. A film capacitor comprising a capacitor element and the composite structure of claim 1.

21. The film capacitor of claim 20, wherein the capacitor comprises:
a capacitor element that includes first metallized films electrically connected to a first termination and second metallized films electrically connected to a second termination;
a case within which the capacitor element is disposed and that defines the first layer of the composite, wherein a space is formed between an inner surface of the case and an outer surface of the capacitor element, and further wherein the second layer of the composite is in contact with the capacitor element and the case and disposed in the space.

22. An electric vehicle comprising a powertrain that includes at least one electric propulsion source and a transmission that is connected to the propulsion source via at least one power electronics module, wherein the electric vehicle comprises the film capacitor of claim 21.

23. The electric vehicle of claim 22, wherein the power electronics module comprises the film capacitor.

24. The electric vehicle of claim 23, wherein the power electronics module includes an inverter that converts direct current to alternating current, wherein the inverter includes the film capacitor.
